(19) United States
(12) Patent Application Publication
(10) Pub. No.: US 2015/0287327 A1
(43) Pub. Date: Oct. 8, 2015

(54) MODULAR SYSTEM FOR INSTRUCTION OF LEARNING DISABLED STUDENTS

(71) Applicant: DETMAR LLC, Richboro, CA (US)

(72) Inventor: Alison Nguyen, Richboro, PA (US)

(73) Assignee: DETMAR LLC

(21) Appl. No.: 14/666,397

(22) Filed: Mar. 24, 2015

Related U.S. Application Data
(60) Provisional application No. 61/975,355, filed on Apr. 4, 2014.

(51) Int. Cl. G09B 1/00; G09B 19/00

(52) U.S. Cl. CPC G09B 1/00; G09B 19/003

(57) ABSTRACT

Included within the scope of the invention is a modular teaching system for instructing a child having one or more learning disabilities. The system includes a display substrate having a mounting surface; at least three modular learning placards affixed to the mounting surface, each placard independently displaying information relating to a topic; and a plurality of reversibly affixable learning devices, each independently presenting information that corresponds to the topic.

Also contemplated within the scope of the invention are educational kits for use in the instruction of a plurality of children having one or more learning disabilities. Such kits may include the teaching system described above and may further include instructor-targeted materials communicating use of the system to the instructor. If such materials are present in the kit, they may be in a format selected from a written format, an electronic format, an audio format and a video format.

### CROSS REFERENCE TO RELATED APPLICATION

This application claims the benefit under 35 U.S.C. §119(e) of U.S. provisional patent application No. 61/975,355, filed Apr. 4, 2014, the entire disclosure of which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF THE INVENTION

A learning disability is a classification including several areas of functioning in which a child has difficulty learning in a typical manner, usually caused by an unknown factor or factors. Generally, learning disabled children have an inadequate development of specific academic, language, and speech skills. All learning disabilities are not the same; types of learning disabilities include reading disability, mathematics disability and writing disability. A child can exhibit one or a combination of any of these disabilities.

The root cause or causes of learning disabilities is not yet well understood. These are generally considered to be result of an individual's ability to receive and process information. This disorder can make it problematic for a person to learn as quickly or in the same way as someone who is not affected by a learning disability. Children with a learning disability have trouble performing specific types of skills or completing tasks if left to figure things out by themselves or if taught in conventional ways.

In majority of public school systems in the United States, children diagnosed as having a learning disability may be placed in a classroom together with the goal of providing additional support to them. However, given that each individual may suffer from a different type or types of learning disability as well as some associated social adjustment difficulties, it is often difficult for the instructor to address each child's needs adequately in a busy classroom environment using the conventional systems and techniques for the learning disabled.

There remains a need in the art for a teaching system that is amenable to alteration to address the varied needs of individuals in a class when each exhibits multiple learning and/or social disabilities, relatively simple to implement, can be used by a single instructor if necessary and utilizes repetition and engagement of all the child's senses to facilitate learning in a classroom environment.

### BRIEF SUMMARY OF THE INVENTION

Included within the scope of the invention is a modular teaching system for instructing a child having one or more learning disabilities. The system includes a display substrate having a mounting surface; at least three modular learning placards affixed to the mounting surface, each placard independently displaying information relating to a topic; and a plurality of reversibly affixable learning devices, each independently presenting information that corresponds to the topic.

Also contemplated within the scope of the invention are educational kits for use in the instruction of a plurality of children having one or more learning disabilities. Such kits may include the teaching system described above and may further include instructor-targeted materials communicating use of the system to the instructor. If such materials are present in the kit, they may be in a format selected from a written format, an electronic format, a audio format and a video format.

### BRIEF DESCRIPTION OF THE SEVERAL VIEWS OF THE DRAWING

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is a schematic representation of the system of the invention with 4 placards and a variety of devices.

### DETAILED DESCRIPTION OF THE INVENTION

The invention includes a teaching system and kits including the system to instruct students with multiple disabilities. Children with multiple disabilities often take quite a long time to fully understand and learn a concept. In order for these students to be successful, the inventor has found that they learn best when exposed to a system that submerges their senses through continuous repeated communication and “hands-on-experiences”. In this way, all of the child's senses are engaged. In addition learning is facilitated by consistent, multiple interactions on basic concepts daily and throughout the year. “Disabilities”, as used herein may include any disorder, lack of ability, condition, etc. that affects a child's ability to learn or socially interact in a mainstream environment, as evaluated by any reputable educational or medical body. They may include, for example an without limitation physical, emotional, or cognitive/learning disabilities or a combination of the same, such as autism, dyslexia, intellectual disability, cerebral palsy, developmental delay, down syndrome, behavioral disorders, lack of motor skills, lack of verbal skills, disabilities or deficiencies resulting from brain injury.

The system and kits included in the invention incorporate directed education through modeling and repetition. In most embodiments of the invention, it is preferred that the student is one with multiple disabilities, severe disabilities, and/or in preschool or grade school with moderate disabilities. Further advantages of the invention include its adaptability to classes having students at a wide variety of educational and social skill levels, its portability, and the fact that it can be easily modified to be implemented in non-English speaking classrooms. The system can be adapted for use with pre-school aged through high school/young adult aged learners. It may also be used at any age to increase, recover, or maintain communication skills, such as, for example in full grown individuals who have suffered stroke or other brain injury.

Moreover, the components actually used in the classroom by the children can be manufactured out of relatively inexpensive materials, if necessary, and are disposable and easily replaceable should they become soiled or contaminated.

In the broadest aspect, the invention includes a modular teaching system that includes a display substrate having a mounting surface, at least three modular learning placards detachably affixed to the mounting surface and a plurality of reversibly affixable learning devices. In most instances, the display substrate is of a larger dimension that both the placards and the devices (so the placards and devices can be mounted on the display substrate).

In most embodiments, the display substrate is a generally rectangular format having an x-dimension of about 1 foot to 6 feet and a y-dimension of about 1.5 feet to 5.5 feet. The display substrate is suspended vertically, either from a wall or other mounting surface or from hooks, bar, curtain rod or the like. It can also be placed on a portable support, such as an easel, or mounted on a tree.

The display surface has a substantially planar surface, although such surface may be textured. The display substrate may be made of virtually any material—preferred suitable material may include textiles, Velcro (loop side or hook side), felts, cardboard, plastics, wood, cork, fiberglass, slate, Styrofoam, foamed polymer sheets, metal sheets, Mylar sheets, paper, laminated materials, especially laminated papers, Bristol boards, poster board, and the like. In some embodiments, the display substrate is made up of more than one material.

The system also includes at least three modular learning placards which are mountable on the display substrate. Such placards may be permanently or detachably affixable, and may be made up of one or more of the materials listed above as suitable for use as the display substrate. By “detachably affixed or affixable” it is meant that the placards remain affixed to the mounting surface under ordinary conditions but can be relatively easily removed. Any mechanism for detachably affixing the placards can be used, for example, hooks, loops, self-renewing adhesives, magnets, static electricity, friction, Velcro, tacks, pins, beads and other mechanical fasteners may be used. The placards may also be “reversibly affixed” meaning that they can be detached from the display substrate and re-affixed with minimal effort (no necessity for re-application of tape or glue, etc.).

When detachably and/or reversibly affixed, the placards can be used to enhance the teaching experience and/or engage the child(ren) (by allowing a child to manipulate the card) or to replace the placard with another to update or change the lesson. In most instances, it may be preferred that the display side of the placard is substantially planar. Reversibly affixed placards can also be used to temporarily move the placard in use within arms-reach of a non-ambulatory child (who cannot approach the display substrate), enabling him to more fully participate in the activity.

Each of the placards independently presents information relating to a topic, for example, an activity, a concept, or an educational subject. Information that is displayed can include, for example, a question to a child or children, a topic heading, a directive, or a title, etc. Such information can be conveyed in words, pictures, symbols, or other signifiers, as is suitable to the child or children using the system. Examples of information/topics that can be presented includes, without limitation, weather, the students' names, the daily schedule, colors, vocabulary word(s), animals, feelings, foods, dining, grooming, sports, mathematical concepts and the like.

Corresponding to each placard are a plurality of learning devices that present information relating to the information presented by the placards. Such devices are reversibly affixable to the placards and/or the display substrate. In an embodiment, the learning devices independently relate or correspond to the information presented on the learning placard(s). Alternatively, the devices can be blank (non-specific) markers (i.e., markers that do not present a word or symbol) that can be used as by the child(ren) as “selectors” to positively identify or eliminate information on the placards. (For example, if a placard contains images of a carrot, a strawberry and a camel, and the children are instructed to identify “fruits”, a blank device may be sued to identify or select the image of the strawberry or, alternatively, to block out the carrot and camel images.

The devices may be 3-dimensional, such as small plush, plastic, rubber or wood toys or other tokens or objects. Alternatively, the devices may be 2-dimensional, most preferably substantially planar. They can be independently prepared out of, for example, any of the materials listed for use in preparing the display substrate.

Each of the learning device(s) may be of any size or shape. However, it may be preferred that they are of a size and shape such that child-sized hands can easily manipulate them but are not so small that a person with less developed fine motor skills would have difficulty grasping them. The learning devices are reversibly affixable, preferably using Velcro or re-usable polymer adhesives.

The system may also include a “communication book” to facilitate the communication and engagement of non-verbal students. Such communication book may contain copies of the learning devices of the system sized and formatted for use by small hands and bound or collected into a booklet, binder, tablet, or similar. In an alternative embodiment, the communication book may be in the form of a laptop or tablet computer onto which images of the learning devices have been loaded. In some embodiments, the communication book also includes other communication devices, such as a page where images or words representing common or foreseeably useful responses can be placed (e.g., “hi”, “yes”, “no”) so that the non-verbal child can participate all aspects of the lesson.

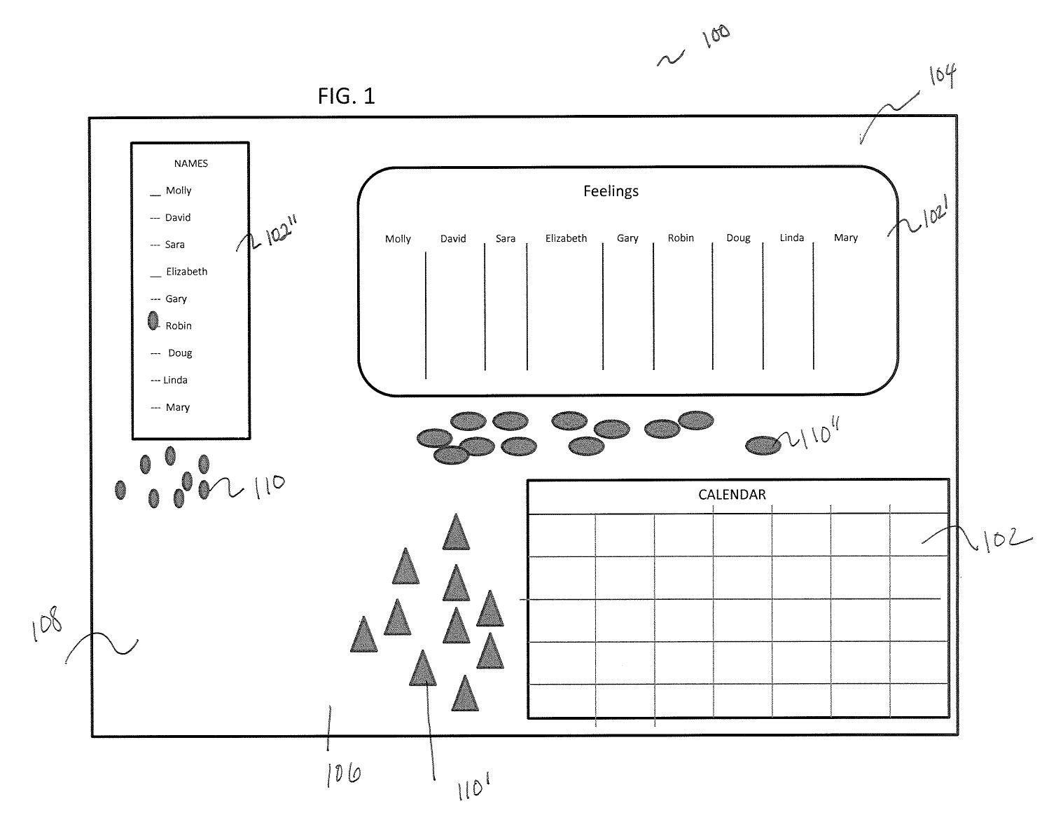

With reference to FIG. 1, the modular teaching system 100 includes one display substrate 104, and several one learning placards 102, 102′, 102″ that are detachably affixed to the mounting surface 106 of the display substrate 104. In an embodiment, the system 100 includes a display substrate 104 includes a substantially planar element 108 that is mountable to a vertical wall of a building, such as a classroom wall, or can be placed on a portable support, such as an easel. The display substrate 104 is preferably a textile.

A least one, preferably at least 3-25, learning placards 104 are detachably affixed to the mounting surface. In the nonlimiting embodiment of FIG. 1, the learning placards 102, 102′, 102″ present information in the form of words (“names”, “feelings”, calendar”).

Each placard independently displays information relating to a topic which the child is to learn and review. The system also includes a plurality of devices 110, 110′, 110″ that are to be used by the child and/or the instructor in conjunction with the learning placards to reinforce the lesson being conveyed by a specific placards. The devices are detachably affixable to the mounting surface, the placard(s) or both as the instructor-student interaction progresses. In some embodiments, when not in use, the devices can be placed on the outer margins of the display substrate for storage.

In the exemplary embodiment shown in FIG. 1, one of the learning placards 102″ is a card displaying the title “Names” and a list of names of each child undergoing instruction. The plurality of devices 110 corresponding to the placard comprises a series of tokens that can be detachably affixed to the placard by a child to identify his name.

The second placard 102′ is a emotions card displaying the title “Feelings” and the names of each of the children involved in the instruction. The plurality of devices 110″ includes tokens displaying a picture representing an emotion or physical sensation, such as, for example, tired, cold, sleepy, peppy, happy, sad, confused, angry, etc.

The third placard 103 is a calendar card displaying the title “Calendar”, with a plurality of devices 110′ having the numbers 1 to 31 on them.

Other exemplary embodiments of the system and its use are explained below.

### “Daily Schedule”

In an embodiment of the modular teaching system, one of the modular learning placards present on the display substrate may be fabricated entirely of Velcro (hook or loop side facing child). The learning placard will convey the information “Daily Schedule”, through use of words or symbols or other means as is suitable to the children being instructed. The reversibly affixable learning devices, in some embodiments, will bear images or words that communicate various activities or tasks to be undertaken in a school day. In this embodiment, the learning devices, each bearing a communication of an activity, are arranged in vertical columns, one column for each student, preferably in the order each task/activity is to be accomplished as the day passes. If desired, the columns may each bear the individual student's name at the top or the student's photograph, if the student is unable to identify his or her name when written.

In this embodiment, the learning devices may include symbols or pictures that convey the following activities (a non-limiting list): bathroom, breakfast, grooming, meeting, snacking, working, art, independent work, ball game, lunch, playing, cleaning up, packing, departing. At the beginning of each school session to which this “Daily Schedule” applies, the instructor will ask each student to identify what task they will be undertaking. The student can then either remove the learning device signifying the task, point to the learning device signifying the task, or use the communication book to identify the device symbolizing the task, depending on each student's individual abilities.

### “Breakfast”

In another embodiment, one of the modular learning placards attached to the display substrate displays information relating to the topic of “breakfast”. The information “breakfast” can be conveyed using words or symbols, such as, for example, an image of a meal (foreground) and sunrise (background). In this embodiment, the plurality of reversibly affixable learning devices includes those relating to a specific breakfast food, cutlery, crockery, or mealtime behavior. Such information can be conveyed using images (such as photos of a pancake stack, a cereal bowl, a fork or a jaw in the process of chewing) or using words (such as “pancake”, “bowl”, “fork”, “chew”).

In this embodiment, the student is informed by the instructor of the type of food which will be consumed for breakfast that day, such as, for example, cereal. The student is presented with the modular placard, to which all of the learning devices have been affixed and he or she is permitted to select, from the devices the one conveying the information relating to breakfast cereal. He or she can do this by either removing the learning device or retaining it, merely pointing to it on the placard, or using the communication book to indicate which learning device he is identifying. As in all of the situations discussed herein, an apparent advantage of the system is that when a student is non-ambulatory (i.e., cannot move from one location to the display substrate), the modular placard can be temporarily removed from the display substrate and provided at close hand to the non-ambulatory student, who can then participate in the same manner as those students are ambulatory.

After selecting cereal, the instructor inquires of the student as to what other things he or she may need that are represented by the information on the learning devices. The student may reply to these questions by pointing to such things as, for example, the device representing information related to a bowl, the device representing information related to a spoon, etc. The student can make the identification by either removing the learning device from the placard or by pointing, or by using the communication book or by placing the device on the placard.

### “Grooming”

In an embodiment using the modular teaching system the display substrate may include a modular learning placard that displays information relating to “grooming”. Such system also includes a plurality of the reversibly affixed ballooning devices which present information relating to activities which one may undertake when in the process of grooming, such as, for example, brushing one's hair, brushing one's teeth, washing one's face, washing one's skin, flossing, washing one's ears, etc. Each learning device can convey the information by use of words or a picture, for example, an image of a toothbrush.

### “Morning Meeting”

In an embodiment of the invention, the learning system can be used to engage with the children in a “morning meeting” to review the various activities and events of the day. In such contacts, the display substrate includes numerous placards, preferably about 10-15, conveying information on topics such as, “calendar”, letter, emotional/physical wellbeing, attendance, dressing and grooming, greetings, weather/appropriate dressing, feelings and/or vocabulary of the day. The display placards and the corresponding learning devices as set forth in Table A below and are used generally as described herein:

TABLE A

| Information of Display | | | | | | | |
|---|---|---|---|---|---|---|---|
| Placard Relates to . . . | Learning Devices Present Information of . . . | | | | | | |
| Greetings | Hello | Goodbye | Cheerio | | | | |
| | Hi | ‘Bye | | | | | |
| Calendar | Months of the Year | | Numerical Dates | | | | |
| | Days of the Week | | Special Holidays (Arbor Day, New Years Day, | | | | |
| | | | MLK Day, etc.) | | | | |
| Weather | Cold | Hot | Sunny | Cloudy | Icy | Thunder | |
| | Warm | Rainy | Windy | Snowy | Lightening | Tornado | |
| Weather Appropriate | Short pants | Sun hat | Long pants | Winter coat | | | |
| Clothing | Swim suit | Sun glasses | Rain hat | Mittens | | | |
| (In Form of Paper Doll) | Tank top | Rain coat | Umbrella | Hat | | | |
| Feelings | Happy | Sad | Angry | Cheerful | | | |
| Vocabulary | Go | Down | Out | Close | Fork | Socks | Breakfast |
| | Up | Get | On | Cup | Spoon | Lunch | Away |
| | Stop | Put | Off | Toy | Shirt | Dinner | Door |
| | Play | In | Open | Plate | Pants | | |

| | | | | |
|---|---|---|---|---|
| Song | Five Little Monkeys | Baby Bumble Bee | Wheels on the Bus | Itsy Bitsy Spider |

| Book | So Many Butterflies | The Day the Sheep Showed Up | Elmo Says Achoo |
|---|---|---|---|
| | (Lara Bergen) | (David McPhail) | (Sarah Albee & Tom Brannon) |
| | Follow That Egg | Diego Saves the Tree Frogs | Pinkalicious |
| | (Catherine Lukas) | (Sarah Willson) | (Victoria & Elizabeth Kann) |
| | The Big Snowball | The Biggest Cookie in the | Don't Let the Pigeon Drive the |
| | (Wendy Lewison) | World | Bus |
| | The Carrot Seed | (Linda Hayward) | (Mo Willems) |
| | (Ruth Krauss) | May I Please Have a Cookie? | Hiccups for Elephant |
| | Frog's Lunch | (Jennifer E. Morris) | (James PreHer) |
| | Dee Lillegard) | DETMAR Letter Books (A-Z) | |
| | | (Alison Nguyen) | |
| Functional | Attributes such as big/little | Matching/identifying quantities | Counting |
| Academics Math | Size | One and many | Money |
| | Numeral Identification | | |
| Functional Academics | Id Elements of a story | Reading comprehension | Sequencing |
| Literacy | Sorting attributes | Sight words | Definition |
| | Summary | Writing | Penmanship |
| Race to the Finish | Counting | Colors | Personal name identification |
| | Sight words | | |
| Independent | Sorting | Stringing Beads | Clothespins |
| Work Station | Nuts and bolts | Puzzles | Badges |
| | Letters | Mail | Clothing |
| | Silverware | Blocks | Money |
| | Matching | | |

As noted above, information conveyed on either the display placards or the learning devices can be communicated by use of words, images or both, as necessitated by the abilities of the children present in the class.

In the beginning of the morning meeting, if the system is also being used with the “daily schedule” aspect of the system described above, the instructor directs the students to check each of their schedules. The students move to the specific schedule column bearing their name or photograph and remove the learning device symbolizing the meeting. They can retain the device or put it a receptacle provided by the instructor. In this embodiment, it may be preferred that they proceed to a specially designated meeting area, sit down and await the instructor.

The instructor refers to the learning placard communicating the topic “greetings” and they can inquire of the students, such as, for example, “what is next”? In reply, the students may individually come to the learning placard and touch or remove the learning device that says “hi” (or shows an image of someone waving hello).

The instructor will then refer to the placard relating to information about attendance, with the corresponding learning devices either bearing the children's names or the children's photographs. The children may indicate who is present or absent by either moving the learning devices from the display substrate onto the placard or removing the appropriate learning devices from the placard to the substrate to indicate who is absent.

The instructor may then further engage the children, make additional inquiries such as, how many children came to school or how many girls came to school, etc. The instructor then refers to the display placard entitled “calendar”. The calendar has several subtypes of corresponding learning devices including, for example, the date numbered 1-31, the days of the week and the names of the months. The instructor will ask the students to indicate which month it is and one or more students may obtain the learning device bearing the title of “October” and place it on the calendar. If this is too difficult, the instructor may give the student a choice between only two months. In the case of non-ambulatory students the student may convey the placard to the student and show the learning devices containing one or more months depending on the abilities of the student. The student would take the correct month and place it on the placard. Similar steps are taken with respect to the days of the week and the numerical dates.

In an embodiment, the instructor may refer to the placard conveying information about the weather. The instructor can show to the students the learning devices bearing the images or words communicating various states of weather. Alternatively, depending on the skill level of the students, the instructor can take out a learning device symbolizing hot and a learning device symbolizing cold and ask the students to select which best describes the weather of the day. Subsequently, the instructor can show to the students a learning device communicating “sun” and a learning device communicating “rain” and ask the students to choose between the two opposite weather states to the one that best describes the day.

The instructor then proceeds to the placard conveying information related to weather appropriate dressing. In an embodiment, the placard is in the shape of a “weather boy” or “weather girl”, i.e. a paper doll-like placard which can be “dressed” using the learning devices which are shaped like various articles of clothing and/or accessories. The instructor can inquire of the students what the weather boy/girl paper doll should be wearing based upon the weather of the day. The student, an ambulatory, can approach the placard and select the learning device that best represents what one might wear, for example, a winter coat, galoshes, a sun hat, etc. If the student is non-ambulatory, the instructor can move the placard into arm's length of the student and he or she can select learning devices as it applies to the placard.

The instructor approaches the placard communicating information about feelings. The instructor provides to the students numerous learning devices which represents either in words or in images, various states of well being, both physical and emotional, for example, angry, happy, sad, etc. Each student is permitted to select from the learning devices the one device or devices which represents his or her feelings.

Similar activities can be carried out using the remainder of the topics in Table A, or the system can be adapted to teach virtually any topic the instructor wishes. Such modifications are with the routine skill of a person in the art.

In some embodiments, the invention includes a kit. The kit includes the system as described above, and instructor-targeted materials for use of the system. In an embodiment, the instructor-targeted materials provide direction and suggestions to the instructor for use of the system in a variety of learning environments and to aid in teaching individuals with variety of disabilities. The instructor-targeted materials may be in any format, for example, they may be a written format, such as a traditional bound book (“teachers' manual”), an electronic format, such as a on a CD or as a downloadable file, in an audio format and in a video format.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A modular teaching system for instructing a child having one or more learning disabilities comprising:
a. a display substrate having a mounting surface;
b. at least three modular learning placards affixed to the mounting surface, each placard independently displaying information relating to a topic;
c. a plurality of reversibly affixable learning devices, each independently presenting information that corresponds to the topic.

2. The system of claim 1, further comprising a communication book.

3. The system of claim 1, wherein the display substrate is a vertical wall.

4. The system of claim 1, wherein the display substrate is a planar element that is mountable to a vertical wall of a building.

5. The system of claim 1, wherein the planar element is selected from a cork board, a wood plank, a textile; a chalk board; cardboard; Bristol board; plastic; and paper.

6. The system of claim 1, wherein the at least three modular learning placards are independently selected from a cork board, a wood plank, a textile; a chalk board; cardboard; Bristol board; plastic; and paper.

7. The system of claim 1, further comprising about five to about 25 modular learning placards.

8. The system of claim 1 wherein one of the learning placards is a card displaying a list of names of each child undergoing instruction and the plurality of devices comprises a series of reversibly affixable tokens that can be affixed to the placard by a child to identify his name.

9. The system of claim 1, wherein one of the learning placards is a daily schedule card and the plurality of devices comprises a card displaying a picture representing a daily activity.

10. The system of claim 9, wherein the daily activity is chosen from bathroom attendance, eating, grooming, meeting, snacking, working, napping, drawing, painting, sculpting, cooking, recreation activity, exercising, listening to music, cleaning and packing.

11. The system of claim 1, wherein one of the learning placards is a weather card and the plurality of devices comprises a device displaying a picture representing a weather condition.

12. The system of claim 11, wherein the weather condition is chosen from sunny, rainy, cloudy, snowy, icy, muddy, cold, hot, and temperate.

13. The system of claim 1, wherein one of the learning placards is a calendar card and the plurality of devices comprises a device displaying a picture or word representing a calendar element.

14. The system of claim 13, wherein the calendar element is selected from a day of the week, a month, a holiday and a calendar date.

15. The system of claim 1, wherein one of the learning placards is an emotions placard and the plurality of devices comprises a device displaying a picture or word representing an emotion.

16. The system of claim 15, wherein the emotion is selected from happy, sad, angry, tired, ill, bored, silly, cheerful, pensive, thoughtful, and scared.

17. The system of claim 1, wherein one of the learning placards is a Word of the Day Placard and the plurality of devices comprises cards, each presenting a single word.

18. An educational kit for use in the instruction of a plurality of children having one or more learning disabilities comprising a teaching system comprising: a display substrate having a mounting surface; at least three modular learning placards detachably affixed to the mounting surface, each placard independently displaying information relating to a topic; and a plurality of reversibly affixable learning devices, each independently presenting information that corresponds to the topic.

19. The kit of claim 18 further comprising instructor-targeted materials for use of system.

20. The kit of claim 19, wherein the instructor targeted materials are in a format selected from a written format, an electronic format, a audio format and a video format.
